(19) United States
(12) Patent Application Publication
(10) Pub. No.: US 2025/0180942 A1
(43) Pub. Date: Jun. 5, 2025

(54) DISPLAY DEVICE AND OPERATION METHOD THEREOF

(71) Applicant: HANNSTAR DISPLAY CORPORATION, Taipei City (TW)

(72) Inventors: Chen-Hao Su, Taichung City (TW); Chia-Feng Teng, Tainan City (TW); Chin-Wei Lin, Tainan City (TW); Chin-Yung Liu, Tainan City (TW)

(73) Assignee: HANNSTAR DISPLAY CORPORATION, Taipei City (TW)

(21) Appl. No.: 18/822,259

(22) Filed: Sep. 1, 2024

(30) Foreign Application Priority Data
Nov. 30, 2023 (TW) 112146464

(51) Int. Cl. G02F 1/13; F21V 8/00

(52) U.S. Cl. CPC G02F 1/1323; G02B 6/0036; G02B 6/0068; G02B 6/0076

(57) ABSTRACT

A display device includes a display, a light-controlling module, a first light source, a second light source, and a third light source. The light-controlling module is disposed under the display panel and includes a first light guide, a second light guide and a diffusion structure. The first light guide includes first microstructures extending in a first direction and arranged in a second direction. The second light guide is disposed on the first light guide, and includes second microstructures extending in the second direction and arranged in the first direction. The diffusion structure is disposed on the second light guide and includes diffusion microstructures. The first light source is disposed on opposite sides of the first light guide in the first direction. The second light source is disposed on opposite sides of the second light guide in the second direction. The third light source is disposed under the first light guide.

### BACKGROUND OF THE INVENTION

### 1. Field of the Invention

The present invention relates to a display device and operation method thereof, and particularly to a display device with an anti-peeping function and an operation method thereof.

### 2. Description of the Prior Art

Modern display devices are designed to have certain advantages, such as being light, thin, and having low power consumption, and are broadly applied to various sorts of electronic devices, e.g. desktop PCs, notebooks, tablets, and smart phones. With increasing demands from users for information security and privacy, the anti-peeping function of a display device has become more and more important. Therefore, one of the objectives of the present invention is to make display devices which are equipped with a better anti-peeping function.

### SUMMARY OF THE INVENTION

The technical problem to be solved by the present invention is to equip display devices with a better anti-peeping function.

In order to solve the above-mentioned technical problem, the present invention provides a display device including a display panel, a light-controlling module, a first light source, a second light source, and a third light source. The light-controlling module is disposed under the display panel, and the light-controlling module includes a first light guide, a second light guide, and a diffusion structure. The first light guide includes a plurality of first microstructures, wherein the first microstructures extend along a first direction and are arranged in a second direction, the first direction is perpendicular to the second direction, any two adjacent first microstructures have a first spacing in the second direction, and the first spacings are gradually reduced from two opposite edges of the first light guide towards an interior of the first light guide in the second direction. The second light guide is disposed on the first light guide. The second light guide comprises a plurality of second microstructures, wherein the second microstructures extend along the second direction and are arranged in the first direction, any two adjacent second microstructures have a second spacing in the first direction, and the second spacings are gradually reduced from two opposite edges of the second light guide towards an interior of the second light guide in the first direction. The diffusion structure is disposed on the second light guide and includes a plurality of diffusion microstructures, wherein each of the diffusion microstructures includes an arc surface. The first light source is disposed on two opposite sides of the first light guide in the first direction. The second light source is disposed on two opposite sides of the second light guide in the second direction. The third light source is disposed under the first light guide.

In order to solve the above-mentioned technical problem, the present invention provides an operation method of a display device including the following procedures. The method first includes providing a display device, wherein the display device includes a display panel, a light-controlling module, a first light source, a second light source, and a third light source. The light-controlling module is disposed under the display panel, and the light-controlling module includes a first light guide, a second light guide, and a diffusion structure. The first light guide includes a plurality of first microstructures, wherein the first microstructures extend along a first direction. The second light guide is disposed on the first light guide and includes a plurality of second microstructures, wherein the second microstructures extend along a second direction, and the first direction is perpendicular to the second direction. The diffusion structure is disposed on the second light guide and includes a plurality of diffusion microstructures, wherein each of the diffusion microstructures includes an arc surface. The first light source is disposed on two opposite sides of the first light guide in the first direction. The second light source is disposed on two opposite sides of the second light guide in the second direction. The third light source is disposed under the first light guide. Afterwards, the method includes turning on one of the first light source and the second light source, and turning on at least a part of the third light source or turning off the third light source.

In the display device and operation method thereof of the present invention, by the position of the first light source, the direction of light emitted from the first light source, and the structural design of the first microstructures of the first light guide, displayed images may be provided with an anti-peeping effect in the second direction. By the position of the second light source, the direction of light emitted from the second light source, and the structural design of the second microstructures of the second light guide, displayed images may be provided with an anti-peeping effect in the first direction. Images displayed by the third light source may not be provided with an anti-peeping effect. By operating different light sources, partial displayed images with the anti-peeping effect, whole displayed images with the anti-peeping effect, and whole displayed images without the anti-peeping effect may be achieved. Therefore, by the design of the light sources and the light guides of the present invention, the display devices may have a more diversified and better anti-peeping effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cross-section view of a display device according to a first embodiment of the present invention.

FIG. 2 is a schematic diagram illustrating a top view of a first light guide of a display device according to the first embodiment of the present invention.

FIG. 3 is a schematic diagram illustrating a cross-section view taken along the line A-A′ in FIG. 2.

FIG. 4 is a schematic diagram illustrating a cross-section view taken along the line B-B′ in FIG. 2.

FIG. 5 is a schematic diagram illustrating a perspective view of a first light guide of a display device according to the first embodiment of the present invention.

FIG. 6 is a schematic diagram illustrating a measured result of a viewing angle of display devices according to an example (i) and an example (ii) of the present invention.

FIG. 7 is a schematic diagram illustrating a top view of a second light guide of a display device according to the first embodiment of the present invention.

FIG. 8 is a schematic diagram illustrating a cross-section view taken along the line C-C′ in FIG. 7.

FIG. 9 is a schematic diagram illustrating a cross-section view taken along the line D-D′ in FIG. 7.

FIG. 10 is a schematic diagram illustrating a top view of a diffusion structure of a display device according to the first embodiment of the present invention.

FIG. 11 is a schematic diagram illustrating a cross-section view of a diffusion structure of a display device according to the first embodiment of the present invention.

FIG. 12 is a schematic diagram illustrating a measured result of a viewing angle of images displayed by a third light source of a display device of the present invention.

FIG. 13 is a flow chart illustrating an operation method of a display device according to the first embodiment of the present invention.

FIG. 14 is a schematic diagram illustrating a part of displayed images with an anti-peeping effect using an operation method of a display device according to the first embodiment of the present invention.

FIG. 15 is a schematic diagram illustrating a perspective view of a first light guide of a display device according to a second embodiment of the present invention.

FIG. 16 is a schematic diagram illustrating a top view of a first light guide of a display device according to a third embodiment of the present invention.

FIG. 17 is a schematic diagram illustrating a cross-section view of a first unit according to the third embodiment of the present invention.

FIG. 18 is a schematic diagram illustrating a top view of a second light guide of a display device according to the third embodiment of the present invention.

FIG. 19 is a schematic diagram illustrating a cross-section view of a first unit according to a fourth embodiment of the present invention.

### DETAILED DESCRIPTION

To provide a better understanding of the present invention to those skilled in this field, preferred embodiments will be detailed as follows. The preferred embodiments of the present invention are illustrated in the accompanying drawings to elaborate on the contents and effects to be achieved. It should be noted that the drawings are simplified schematics, and therefore show only the components and combinations associated with the present invention, in order to provide a clearer description of the basic architecture or method of implementation. The components would be complex in reality. In addition, for ease of explanation, the components shown in the drawings may not represent their actual number, shape, and dimensions; details can be adjusted according to design requirements.

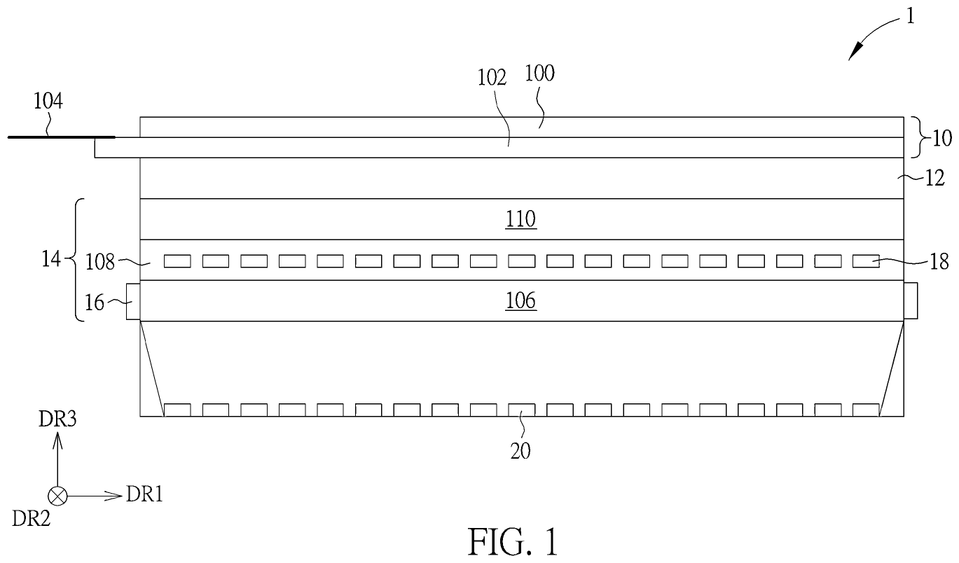

A direction DR1, a direction DR2, and a direction DR3 are shown in the following figures. The direction DR3 may be a normal direction or a top view direction. As shown in FIG. 1, the direction DR3 may be perpendicular to an upper surface of a display device 1. As shown in FIG. 1, the direction DR1 and the direction DR2 may be horizontal directions and may be perpendicular to the direction DR3. The direction DR1 is different from the direction DR2. For example, the direction DR1 may be perpendicular to the direction DR2. The spatial relationship of structures can be described according to the directions DR1 and DR2 in the following drawings.

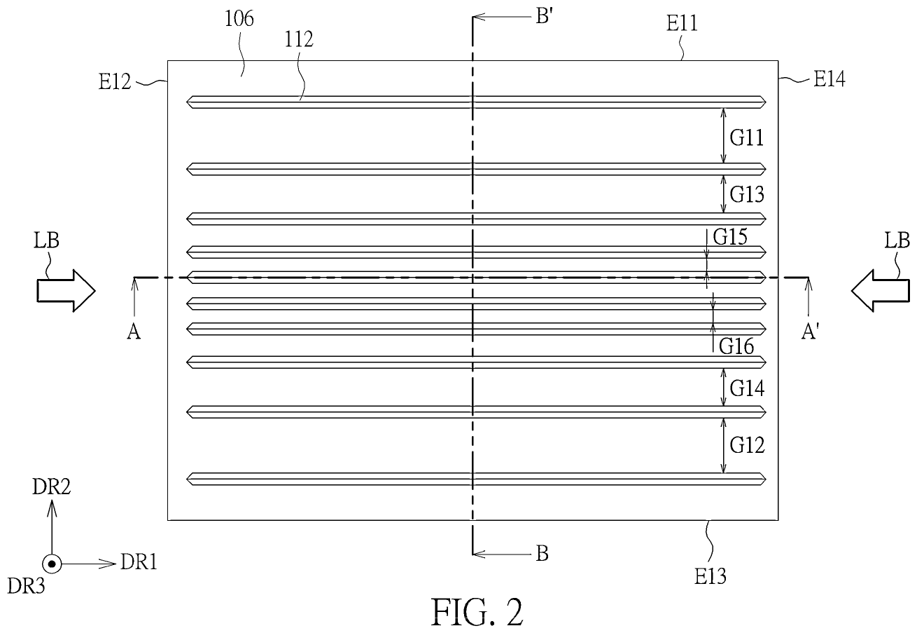

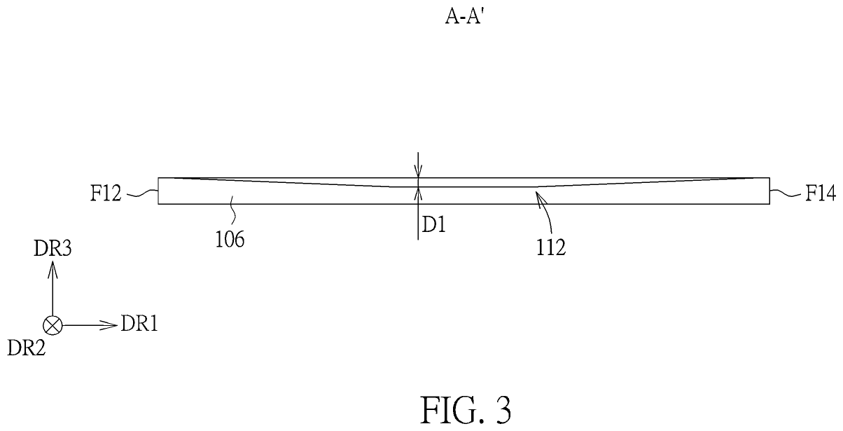

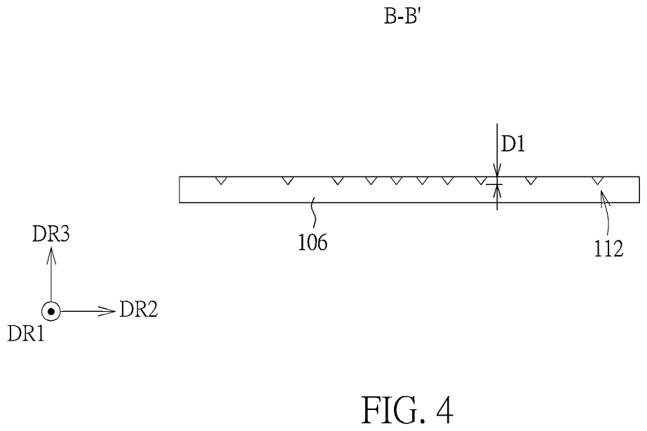

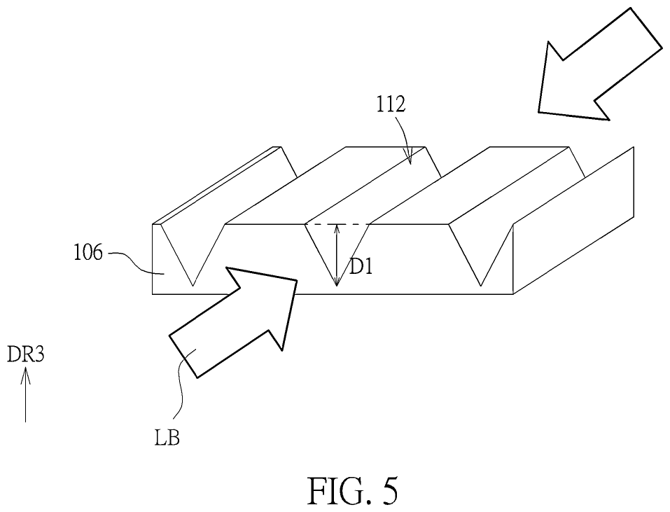

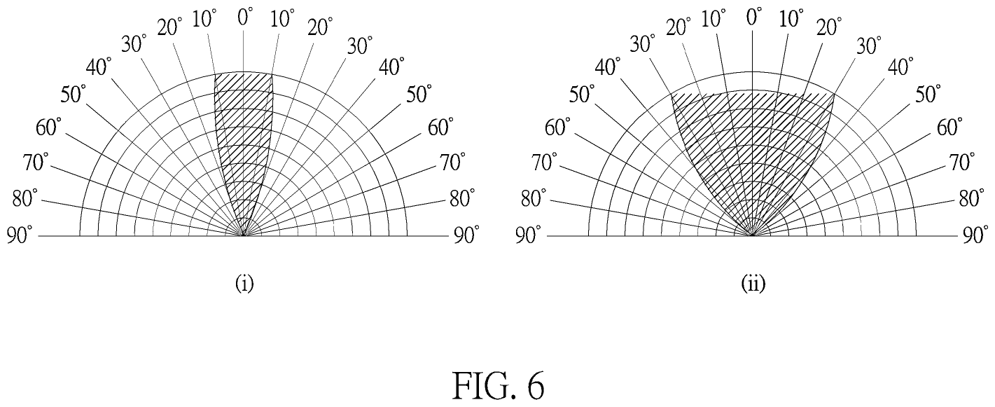

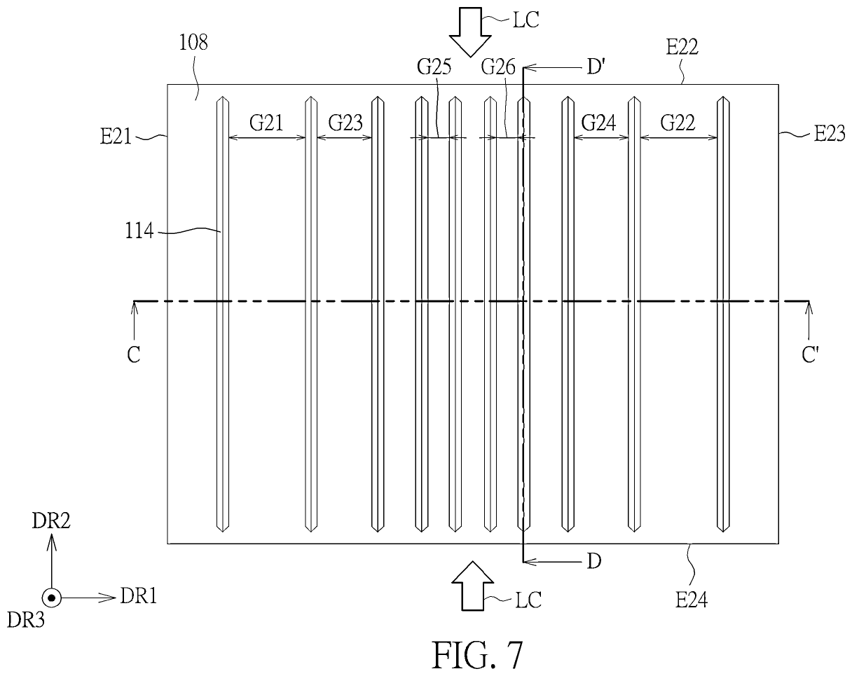

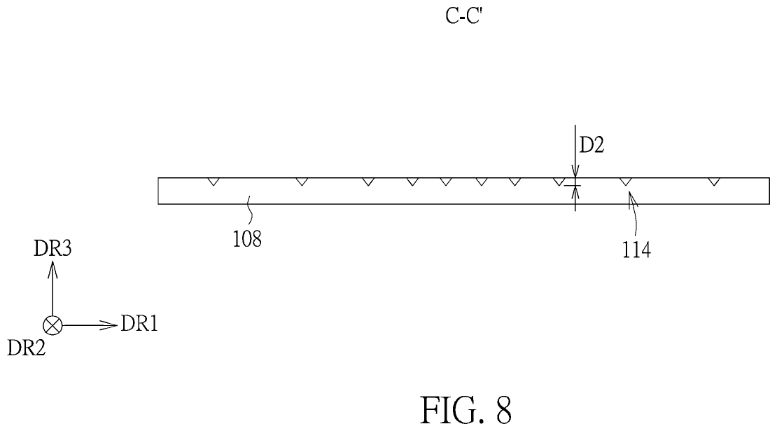

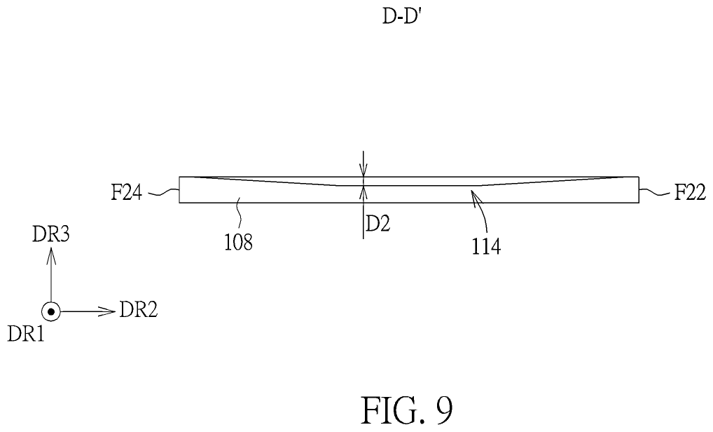

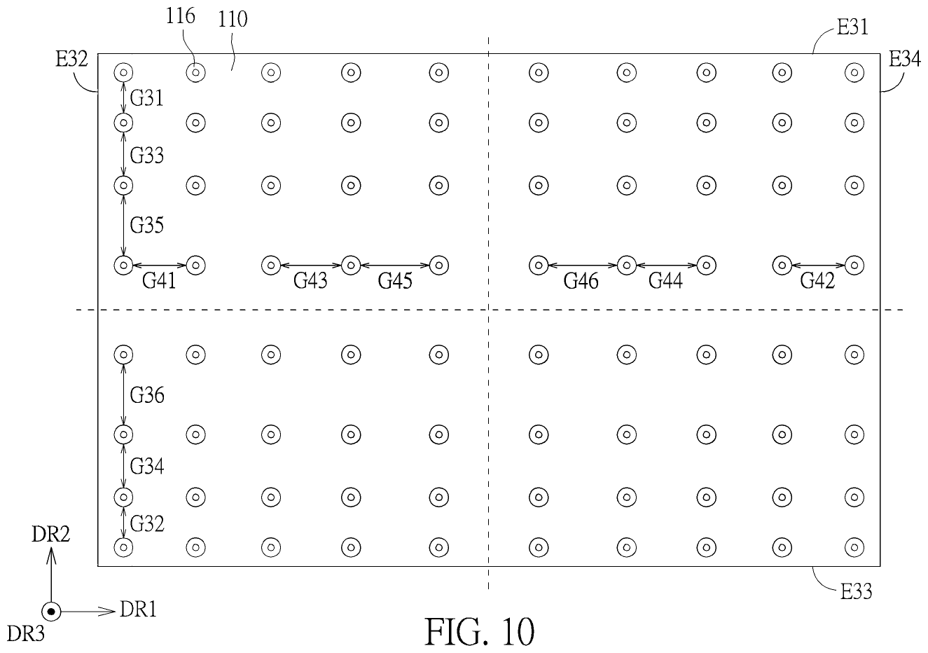

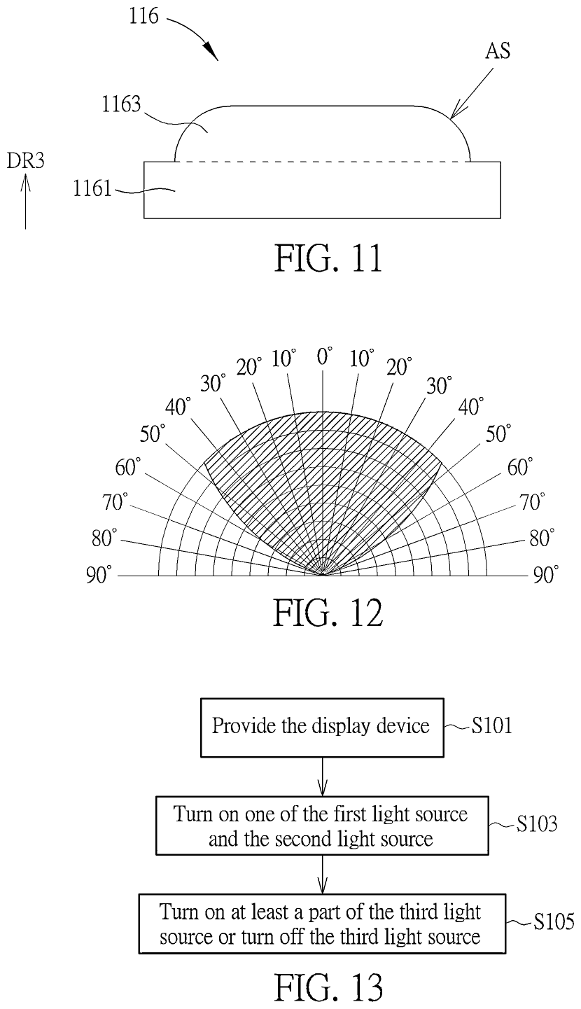

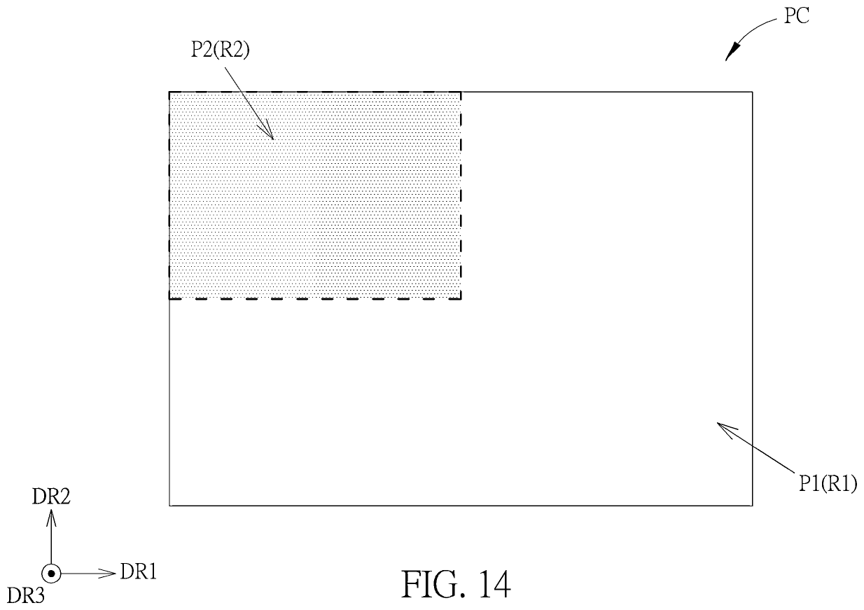

Refer to FIG. 1 to FIG. 14. FIG. 1 is a schematic diagram illustrating a cross-section view of a display device according to a first embodiment of the present invention. FIG. 2 is a schematic diagram illustrating a top view of a first light guide of a display device according to the first embodiment of the present invention. FIG. 3 is a schematic diagram illustrating a cross-section view taken along the line A-A′ in FIG. 2. FIG. 4 is a schematic diagram illustrating a cross-section view taken along the line B-B′ in FIG. 2. FIG. 5 is a schematic diagram illustrating a perspective view of a fist light guide of a display device according to the first embodiment of the present invention. FIG. 6 is a schematic diagram illustrating a measured result of viewing angle of display devices according to an example (i) and an example (ii) of the present invention. FIG. 7 is a schematic diagram illustrating a top view of a second light guide of a display device according to the first embodiment of the present invention. FIG. 8 is a schematic diagram illustrating a cross-section view taken along the line C-C′ in FIG. 7. FIG. 9 is a schematic diagram illustrating a cross-section view taken along the line D-D′ in FIG. 7. FIG. 10 is a schematic diagram illustrating a top view of a diffusion structure of a display device according to the first embodiment of the present invention. FIG. 11 is a schematic diagram illustrating a cross-section view of a diffusion structure of a display device according to the first embodiment of the present invention. FIG. 12 is a schematic diagram illustrating a measured result of viewing angle of images displayed by a third light source of a display device of the present invention. FIG. 13 is a flow chart illustrating an operation method of a display device according to the first embodiment of the present invention. FIG. 14 is a schematic diagram illustrating a part of displayed images with an anti-peeping effect of an operation method of a display device according to the first embodiment of the present invention.

The display device 1 includes a display panel 10, an optical film layer 12, a light-controlling module 14, a first light source 16, a second light source 18, and a third light source 20. The display panel 10 may be a liquid crystal display panel, but is not limited thereto. The display panel 10 may include a substrate 100, a substrate 102, and a soft electric board 104, but is not limited thereto. The substrate 100 may be disposed on the substrate 102, and the soft electric board 104 may be connected to one side of the substrate 102. The substrate 100 and the substrate 102 may include hard substrates, for example, glass substrate, quartz substrate, or sapphire substrate, but not limited thereto. The substrate 100 and the substrate 102 may further include soft substrates, for example, polyimide (PI) substrate or polyethylene terephthalate (PET) substrate, but not limited thereto.

The light-controlling module 14 is disposed under the display panel 10, and the optical film layer 12 is disposed between the light-controlling module 14 and the display panel 10. The optical film layer 12 may include one or multiple sub-film layers to provide a suitable optical effect, but is not limited thereto. The light-controlling module 14 may include a first light guide 106, a second light guide 108, and a diffusion structure 110. As shown in FIG. 1, the first light guide 106 is disposed on the bottom of the light-controlling module 14, the second light guide 108 is disposed on the first light guide 106, and the diffusion structure 110 is disposed on the second light guide 108.

As shown in FIG. 2 and FIG. 5, the first light guide 106 includes a plurality of first microstructures 112, and the first microstructures 112 may be disposed on an upper surface of the first light guide 106, but not limited thereto. As shown in FIG. 2, the first microstructures 112 extend along the direction DR1 and are arranged in the direction DR2. Any two adjacent first microstructures 112 have a first spacing in the direction DR2, and the first spacings are gradually reduced from two opposite edges, E11 and E13, of the first light guide 106 towards an interior of the first light guide 106 in the direction DR2. For example, a first spacing G11 may be greater than a first spacing G13, and the first spacing G13 may be greater than a first spacing G15. In another example, a first spacing G12 may be greater than a first spacing G14, and the first spacing G14 may be greater than a first spacing G16.

As shown in FIG. 2 and FIG. 5, each of the first microstructures 112 of this embodiment includes a recess, but is not limited thereto. As shown in FIG. 3 and FIG. 4, the recess of the first microstructure 112 has a depth D1. As shown in FIG. 3, the depth D1 becomes gradually deeper from two opposing end, F12 and F14, of the first microstructure 112 towards a center of the first microstructure 112 in the direction DR1. The design of the above-mentioned first spacing and the depth D1 of the recess may enhance the homogeneity of the light distribution.

As shown in FIG. 1, the first light source 16 is disposed on opposite sides of the first light guide 106 in the direction DR1. The first light source 16 may, for example, be an edge-lit light source and include a plurality of LEDs disposed on the opposite sides of the first light guide 106. Therefore, light LB emitting from the first light source 16 may be emitted to the first light guide 106 in the direction shown in FIG. 2 and FIG. 5, and a direction of the light LB may be parallel to an extending direction of the first microstructures 112, which is the direction DR1.

As shown in FIG. 1, the light LB emitting from the first light source 16 may be refracted and reflected by the first light guide 106, pass upward through the second light guide 108 and the diffusion structure 110 in sequence, then be emitted to the display panel 10, and finally be seen by a user. By the position of the first light source 16, the direction of light LB, and a structural design of the first microstructures 112 of the first light guide 106, displayed images may be provided with visibility in the direction DR1 and an anti-peeping effect in the direction DR2. Visibility of the displayed images in the direction DR2 may, with a design of an angle between each plane of the first microstructure 112, have an effect as shown in an example (i) and an example (ii) of FIG. 6. In the direction DR2 and a direction opposite to the direction DR2, a viewing angle may be smaller than or equal to 15 degrees according to the example (i), or the viewing angle may be smaller than or equal to 40 degrees according to the example (ii).

As shown in FIG. 7, the second light guide 108 includes a plurality of second microstructures 114, and the second microstructures 114 may be disposed on an upper surface of the second light guide 108, but not limited thereto. The second microstructures 114 extend along the direction DR2 and are arrange in the direction DR1. Any two adjacent second microstructures 114 have a second spacing in the direction DR1, and the second spacings are gradually reduced from two opposite edges, E21 and E23, of the second light guide 108 towards an interior of the second light guide 108 in the direction DR1. For example, a second spacing G21 may be greater than a second spacing G23, and the second spacing G23 may be greater than a second spacing G25. In another example, a second spacing G22 may be greater than a second spacing G24, and the second spacing G24 may be greater than a second spacing G26.

Similar to the first microstructures 112, each of the second microstructures 114 of this embodiment also includes a recess, but is not limited thereto. As shown in FIG. 8 and FIG. 9, the recess of the second microstructure 114 has a depth D2. As shown in FIG. 9, the depth D2 becomes gradually larger from two opposing ends, F22 and F24, of the second microstructure 114 towards a center of the second microstructure 114 in the direction DR2. The design of the above-mentioned second spacing and the depth D2 of the recess may enhance the homogeneity of the light distribution.

As shown in FIG. 1, the second light source 18 is disposed on opposite sides of the second light guide 108 in the direction DR2. The second light source 18 may, for example, be an edge-lit light source and include a plurality of LEDs disposed on the opposite sides of the second light guide 108. Therefore, light LC emitting from the second light source 18 may be emitted to the second light guide 108 in the direction shown in FIG. 7, and a direction of the light LC may be parallel to an extending direction of the second microstructures 114, which is the direction DR2.

As shown in FIG. 1, the light LC emitting from the second light source 18 may be refracted and reflected by the second light guide 108, pass upward through the diffusion structure 110, then be emitted to the display panel 10, and finally be seen by the user. By the position of the second light source 18, the direction of light LC, and a structural design of the second microstructures 114 of the second light guide 108, the displayed images may be provided with visibility in the direction DR2 and an anti-peeping effect in the direction DR1. Visibility of the displayed images in the direction DR1 may have the effect shown in the example (i) and the example (ii) of FIG. 6. In the direction DR1 and a direction opposite to the direction DR1, the viewing angle may be smaller than or equal to 15 degrees according to the example (i), or the viewing angle may be smaller than or equal to 40 degrees according to the example (ii).

As shown in FIG. 10, the diffusion structure 110 includes a plurality of diffusion microstructures 116, and the diffusion microstructures 116 may be disposed on an upper surface of the diffusion structure 110, but not limited thereto. As shown in FIG. 10, a shape of the diffusion microstructure 116 may be a circle in the top view, but is not limited thereto. As shown in FIG. 11, in the cross-section view, each of the diffusion microstructures 116 may include a bottom part 1161 and an upper part 1163. The bottom part 1161 may be a rectangle, and a width of the bottom part 1161 may be larger than a width of the upper part 1163. The upper part 1163 is disposed on the bottom part 1161, and a side surface of the upper part 1163 is an arc surface AS, but is not limited thereto.

As shown in FIG. 10, any two adjacent diffusion microstructures 116 have a third spacing in the direction DR2, and the third spacings are gradually increased from two opposite edges, E31 and E33, of the diffusion structure 110 towards an interior of the diffusion structure 110. For example, a third spacing G31 may be smaller than a third spacing G33, and the third spacing G33 may be smaller than a third spacing G35. In another example, a third spacing G32 may be smaller than a third spacing G34, and the third spacing G34 may be smaller than a third spacing G36.

Any two adjacent diffusion microstructures 116 have a fourth spacing in the direction DR1, and the fourth spacings are gradually increased from two opposite edges, E32 and E34, of the diffusion structure 110 towards an interior of the diffusion structure 110. For example, a fourth spacing G41 may be smaller than a fourth spacing G43, and the fourth spacing G43 may be smaller than a fourth spacing G45. In another example, a fourth spacing G42 may be smaller than a fourth spacing G44, and the fourth spacing G44 may be smaller than a fourth spacing G46. The arrangement design of the above-mentioned diffusion microstructures 116 may enhance the homogeneity of the light distribution.

As shown in FIG. 1, the third light source 20 is disposed under the first light guide 106. For example, the third light source 20 may be a direct-lit light source and include a plurality of LEDs disposed under the first light guide 106. Therefore, light emitting from the third light source 20 may be emitted upward to the light-controlling module 14. For example, the light emitting from the third light source 20 may sequentially pass through the first light guide 106, the second light guide 108, the diffusion structure 110, then be emitted to the display panel 10, and finally be seen by the user. As shown in FIG. 12, a viewing angle of displayed images lit by the third light source 20 in different directions (e.g., the direction DR1, the direction DR2, and other directions) may be smaller than or equal to 60 degrees. In other words, displayed images of the display panel 10 lit by the third light source 20 may not have the anti-peeping effect when the viewing angle is below 60 degrees in different directions.

As shown in FIG. 13, the present invention further provides an operation method of the display device 1. It should be understand that procedures shown in FIG. 13 may not be complete, and other procedures may be performed before, after, or between the procedures shown. Besides, some procedures may be performed at the same time or in a different sequence than a sequence shown in FIG. 13.

Refer to FIG. 1 to FIG. 13. Firstly, procedure S101 may be performed, which includes providing the display device 1. The display device 1 includes the display panel 10, the light-controlling module 14, the first light source 16, the second light source 18, and the third light source 20, but is not limited thereto. The light-controlling module 14 is disposed under the display panel 10, and the light-controlling module 14 includes the first light guide 106, the second light guide 108, and the diffusion structure 110. The first light guide 106 includes the first microstructures 112, and the first microstructures 112 extend along the direction DR1. The second light guide 108 is disposed on the first light guide 106 and includes the second microstructures 114, and the second microstructures 114 extend along the direction DR2. The diffusion structure 110 is disposed on the second light guide 108 and includes diffusion microstructures 116, wherein each of the diffusion microstructures 116 includes the arc surface AS. The first light source 16 is disposed on two opposite sides of the first light guide 106 in the direction DR1. The second light source 18 is disposed on two opposite sides of the second light guide 108 in the direction DR2. The third light source 20 is disposed under the first light guide 106.

Afterwards, procedure S103 may be performed, which includes turning on one of the first light source 16 and the second light source 18. Then, procedure S105 may be performed, which includes turning on at least a part of the third light source 20 or turning off the third light source 20.

As shown in FIG. 14, a displayed image PC provided by the display panel 10 may include a first part P1 and a second part P2. When the third light source 20 is the direct-lit light source, a first region R1 of the third light source 20 may, in the direction DR3, correspond to the first part P1 of the displayed image PC, while a second region R2 of the third light source 20 may, in the direction DR3, correspond to the second part P2 of the displayed image PC.

In an embodiment, the first light source 16 may be turned on, the second light source 18 may be turned off, the first region R1 of the third light source 20 may be turned on, and the second region R2 of the third light source 20 may be turned off. In the first part P1 of the displayed image PC, although the light LB emitting from the first light source 16 and the first light guide 106 may equip displayed images with the anti-peeping effect, light emitting from the turned-on first region R1 of the third light source 20 may not equip displayed images with the anti-peeping effect. Therefore, the first part P1 of the displayed image PC may still not have the anti-peeping effect.

In the second part P2 of the displayed image PC, the light LB emitting from the first light source 16 and the first light guide 106 may equip displayed images with the anti-peeping effect, and the second region R2 of the third light source 20 is turned off. Therefore, the second part P2 of the displayed image PC may have the anti-peeping effect. Furthermore, for the position of the first light source 16 and the structural design of the first microstructures 112 of the first light guide 106, the second part P2 of the displayed image PC may have the visibility in the direction DR1 and the anti-peeping effect in the direction DR2.

In another embodiment, the first light source 16 may be turned off, the second light source 18 may be turned on, the first region R1 of the third light source 20 may be turned on, and the second region R2 of the third light source 20 may be turned off. In the first part P1 of the displayed image PC, although the light LC emitting from the second light source 18 and the second light guide 108 may equip displayed images with the anti-peeping effect, light emitting from the turned-on first region R1 of the third light source 20 may not equip displayed images with the anti-peeping effect. Therefore, the first part P1 of the displayed image PC may still not have the anti-peeping effect.

In the second part P2 of the displayed image PC, the light LC emitting from the second light source 18 and the second light guide 108 may equip displayed images with the anti-peeping effect, and the second region R2 of the third light source 20 is turned off. Therefore, the second part P2 of the displayed image PC may have the anti-peeping effect. Furthermore, for the position of the second light source 18 and the structural design of the second microstructures 114 of the second light guide 108, the second part P2 of the displayed image PC may have the visibility in the direction DR2 and the anti-peeping effect in the direction DR1.

Therefore, in the above-mentioned two embodiments, as at least a part of the third light source 20 is turned on, the first region R1 of the third light source 20 will be turned on and the second region R2 of the third light source 20 will be turned off.

In another embodiment, one of the first light source 16 and the second light source 18 may be turned on while the other one of the first light source 16 and the second light source 18 may be turned off, and the third light source 20 may be turned off. As the first region R1 and the second region R2 of the third light source 20 are turned off, the first part P1 and the second part P2 of the displayed image PC both may have the anti-peeping effect. That is, the whole displayed image PC has the anti-peeping effect.

In another embodiment, one of the first light source 16 and the second light source 18 may be turned on while the other one of the first light source 16 and the second light source 18 may be turned off, and the entire third light source 20 may be turned on. As the entire third light source 20 is turned on, a brightness of the third light source 20 is less than 20% of a maximum brightness of the third light source 20. Although turning on the third light source 20 may affect the anti-peeping effect of the displayed image PC, as the brightness of the third light source 20 is less than 20% of the maximum brightness of the third light source 20, the displayed image PC may still have the anti-peeping effect, and a brightness of the displayed image PC may be increased, which further improves a quality of the displayed image PC.

The operation method of the display device 1 of the present invention is not limited thereto and may be modified according to different needs for the displayed images.

The display device of the present invention is not limited to the aforementioned embodiment. The following description details other embodiments. To simplify the description and show the difference between other embodiments and the above-mentioned embodiment, identical in components each of the following embodiments are marked with identical symbols, and the identical features will not be redundantly described. The following embodiments all may achieve the effect of the first embodiment.

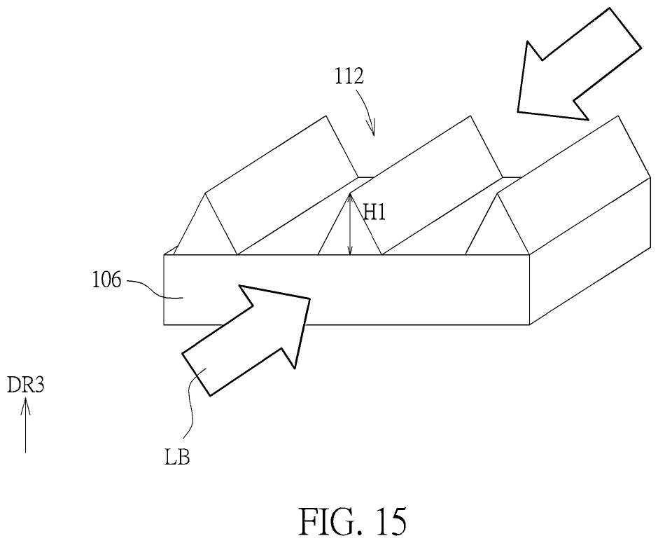

Refer to FIG. 15. FIG. 15 is a schematic diagram illustrating a perspective view of a first light guide of a display device according to a second embodiment of the present invention. The difference between the first embodiment and this embodiment is that each of the first microstructures 112 of this embodiment includes a protrusion. As shown in FIG. 15 (referring to FIG. 2 and FIG. 7 for comparison), the protrusion of the first microstructure 112 has a height H1. The height H1 becomes gradually taller from two opposing ends, F12 and F14, of the first microstructure 112 towards the center of the first microstructure 112 in the direction DR1. Each of the second microstructures 114 of this embodiment also includes a protrusion. The protrusion of the second microstructure 114 has a height. The height becomes gradually taller from two opposing ends, F22 and F24, of the second microstructure 114 towards the center of the second microstructure 114 in the direction DR2.

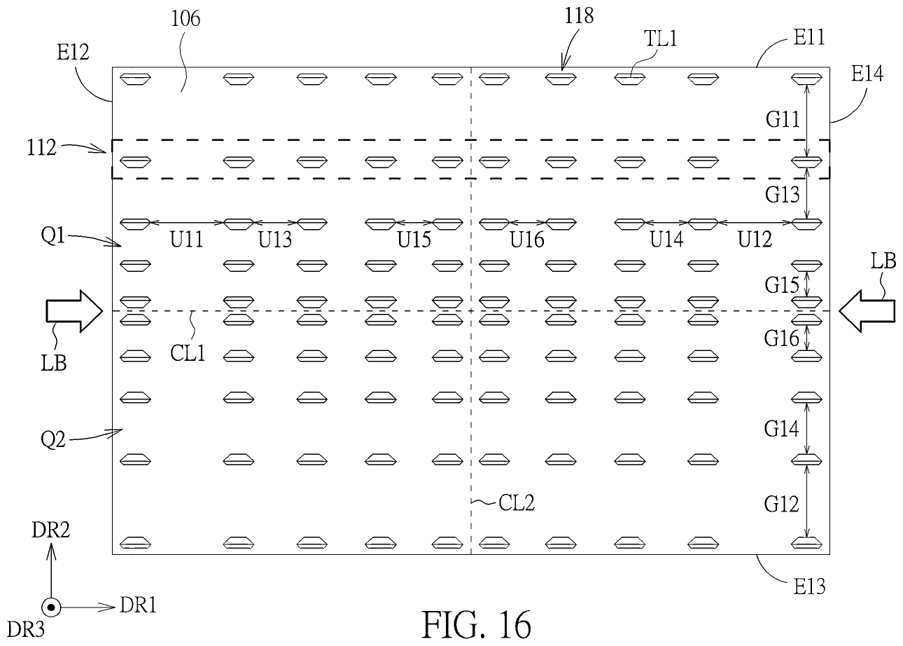

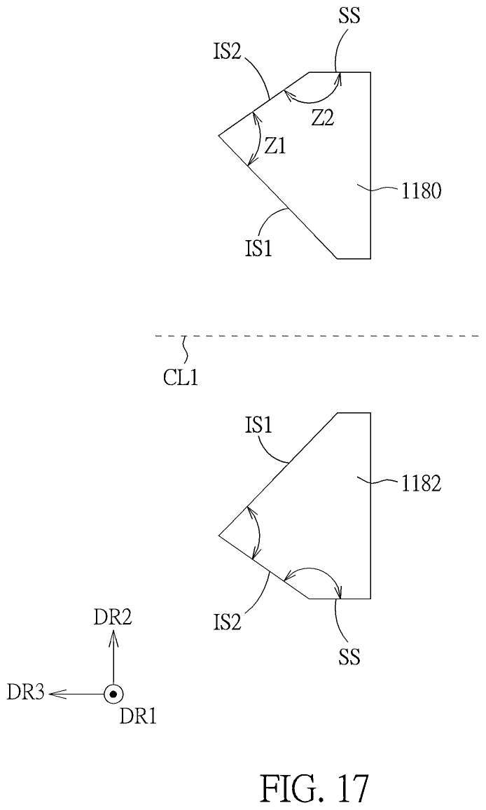

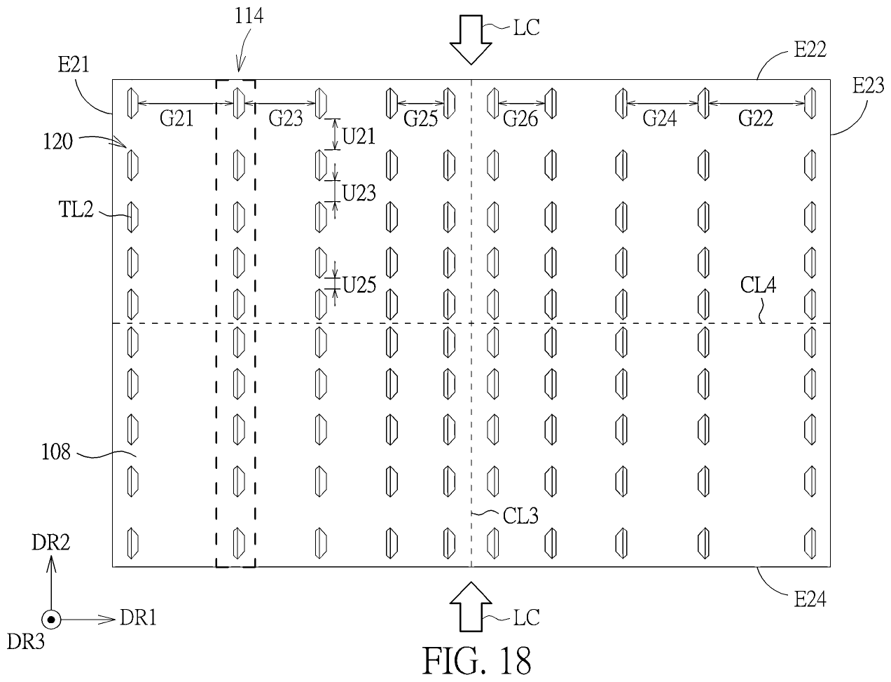

Refer to FIG. 16 to FIG. 18. FIG. 16 is a schematic diagram illustrating a top view of a first light guide of a display device according to a third embodiment of the present invention. FIG. 17 is a schematic diagram illustrating a cross-section view of a first unit according to the third embodiment of the present invention. FIG. 18 is a schematic diagram illustrating a top view of a second light guide of a display device according to the third embodiment of the present invention. The difference between the first embodiment and this embodiment is that each of the first microstructures 112 of the first light guide 106 of this embodiment includes a plurality of first units 118. In each of the first microstructures 112, the first units 118 are arranged in the direction DR1, wherein any two adjacent first units 118 have a unit spacing, and the unit spacings are gradually reduced from two opposite edges, E12 and E14, of the first light guide 106 towards the interior of the first light guide 106 in the direction DR1. For example, a unit spacing U11 may be greater than a unit spacing U13, and the unit spacing U13 may be greater than a unit spacing U15. In another example, a unit spacing U12 may be greater than a unit spacing U14, and the unit spacing U14 may be greater than a unit spacing U16.

In FIG. 16, a cross-section structure of any adjacent two of the first units 118 on two respective sides of a center line CL1 is shown by a first unit 1180 and a first unit 1182 in FIG. 17. As shown in FIG. 17, each of the first units (e.g., 1180 and 1182) includes a first inclined plane IS1 and a second inclined plane IS2, and the first inclined plane IS1 is connected to the second inclined plane IS2. In this embodiment, a connection of the first inclined plane IS1 and the second inclined plane IS2 forms a protrusion, but is not limited thereto. A slope of the first inclined plane IS1 is different from a slope of the second inclined plane IS2. An angle Z1 between the first inclined plane IS1 and the second inclined plane IS2 may be an acute angle (for example, 78 degrees), and an angle Z2 between the second inclined plane IS2 and a side surface SS may be an obtuse angle (for example, 147 degrees), but not limited thereto.

As shown in FIG. 17, the first inclined planes IS1 of the first unit 1180 and the first unit 1182 are disposed near the center line CL1, while the second inclined planes IS2 of the first unit 1180 and the first unit 1182 are disposed away from the center line CL1. Therefore, shapes of the first unit 1180 and the first unit 1182 are symmetrical with respect to the center line CL1, such that they have mirror-symmetry shapes.

As shown in FIG. 16, the first light guide 106 includes a first district Q1, a second district Q2, and the center line CL1 between the first district Q1 and the second district Q2. The center line CL1 is parallel to the direction DR1. The first district Q1 and the second district Q2 are respectively disposed on two opposite sides of the center line CL1 in the direction DR2. A shape of the first units 118 disposed in the first district Q1 and a shape of the first units 118 disposed in the second district Q2 are symmetrical with respect to the center line CL1.

The first light guide 106 may further include a center line CL2. The center line CL2 is parallel to the direction DR2. The first units 118 disposed on two opposite sides of the center line CL2 may also be symmetrical with respect to the center line CL2.

In addition, as shown in FIG. 16, the connection of the first inclined plane IS1 and the second inclined plane IS2 of the first unit 118 include a connecting line TL1, and the connecting line TL1 is parallel to the direction DR1. Therefore, in this embodiment, the direction of the light LB emitting from the first light source 16 may be parallel to the arrangement direction of the first units 118 of the first microstructure 112 and the connecting line TL1 of the first unit 118.

As shown in FIG. 18, each of the second microstructures 114 of the second light guide 108 of this embodiment includes a plurality of second units 120. In each of the second microstructures 114, the second units 120 are arranged in the direction DR2. Any two adjacent second units 120 have a unit spacing, and the unit spacings are gradually reduced from two opposite edges, E22 and E24, of the second light guide 108 towards the interior of the second light guide 108 in the direction DR2. For example, a unit spacing U21 may be greater than a unit spacing U23, and the unit spacing U23 may be greater than a unit spacing U25.

A shape of the second units 120 may be identical to the shape of the first units 118. The difference between the second units 120 and the first units 118 is that a connecting line TL2 between the first inclined plane IS1 and the second inclined plane IS2 of the second unit 120 is parallel to the direction DR2. Therefore, the direction of the light LC emitting from the second light source 18 may be parallel to the arrangement direction of the second units 120 of the second microstructure 114 and the connecting line TL2 of the second unit 120.

In addition, the second light guide 108 may include a center line CL3 and a center line CL4. The center line CL3 is parallel to the direction DR2, and the center line CL4 is parallel to the direction DR1. The second units 120 disposed on two opposite sides of the center line CL3 may be symmetrical with respect to the center line CL3. Also, the second units 120 disposed on two opposite sides of the center line CL4 may be symmetrical with respect to the center line CL4.

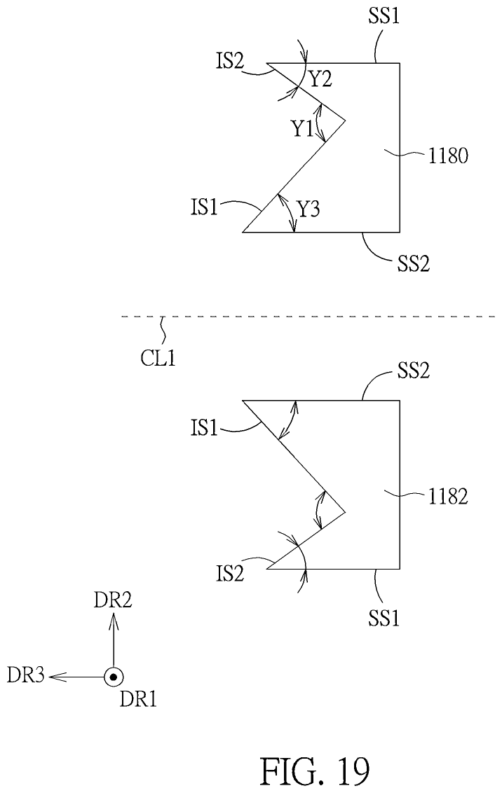

Refer to FIG. 19. FIG. 19 is a schematic diagram illustrating a cross-section view of a first unit according to a fourth embodiment of the present invention. The difference between the third embodiment and this embodiment is that the connection of the first inclined plane IS1 and the second inclined plane IS2 of the first unit 118 and the second unit 120 in this embodiment forms a recess. Taking the first unit 1180 in FIG. 19 as an example, the slope of the first inclined plane IS1 is different from the slope of the second inclined plane IS2. An angle Y1 between the first inclined plane IS1 and the second inclined plane IS2 may be an acute angle (for example, 78 degrees), an angle Y2 between the second inclined plane IS2 and a side surface SS1 may be an acute angle (for example, 33 degrees), and an angle Y3 between the first inclined plane IS1 and a side surface SS2 may be an acute angle (for example, 45 degrees), but not limited thereto. Furthermore, a shape of the first unit 1180 and a shape of the first unit 1182 are symmetrical with respect to the center line CL1. The second units 120 also have the identical structural design of the recess of the first unit 1180 and the first unit 1182.

In summary, in the display device and operation method thereof of the present invention, by the position of the first light source, the direction of light emitted from the first light source, and the structural design of the first microstructure of the first light guide, displayed images may be provided with the anti-peeping effect in the second direction. By the position of the second light source, the direction of light emitted from the second light source, and the structural design of the second microstructure of the second light guide, displayed images may be provided with the anti-peeping effect in the first direction. Images displayed by the third light source may not be provided with the anti-peeping effect. By operating different light t sources, partial displayed images with the anti-peeping effect, whole displayed images with the anti-peeping effect, and whole displayed images without the anti-peeping effect may be achieved. Therefore, by the design of the light sources and the light guides of the present invention, display devices may have a more diversified and better anti-peeping effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device, comprising:
a display panel;
a light-controlling module disposed under the display panel, wherein the light-controlling module comprises:
a first light guide comprising a plurality of first microstructures, wherein the first microstructures extend along a first direction and are arranged in a second direction, the first direction is perpendicular to the second direction, any two adjacent first microstructures have a first spacing in the second direction, and the first spacings are gradually reduced from two opposite edges of the first light guide towards an interior of the first light guide in the second direction;
a second light guide disposed on the first light guide, the second light guide comprising a plurality of second microstructures, wherein the second microstructures extend along the second direction and are arranged in the first direction, any two adjacent second microstructures have a second spacing in the first direction, and the second spacings are gradually reduced from two opposite edges of the second light guide towards an interior of the second light guide in the first direction; and
a diffusion structure disposed on the second light guide and comprising a plurality of diffusion microstructures, wherein each of the diffusion microstructures comprises an arc surface;
a first light source disposed on two opposite sides of the first light guide in the first direction;
a second light source disposed on two opposite sides of the second light guide in the second direction; and
a third light source disposed under the first light guide.

2. The display device according to claim 1, wherein each of the first microstructures comprises a protrusion, the protrusion has a height, and the height becomes gradually taller from two ends of the first microstructure towards a center of the first microstructure in the first direction.

3. The display device according to claim 1, wherein each of the first microstructures comprises a recess, the recess has a depth, and the depth becomes gradually deeper from two ends of the first microstructure towards a center of the first microstructure in the first direction.

4. The display device according to claim 1, wherein each of the first microstructures comprises a plurality of first units, and the first units are arranged in the first direction.

5. The display device according to claim 4, wherein any two adjacent first units have a unit spacing and the unit spacings are gradually reduced from two opposite edges of the first light guide towards an interior of the first light guide in the first direction.

6. The display device according to claim 4, wherein each of the first units comprises a first inclined plane and a second inclined plane, the first inclined plane is connected to the second inclined plane, and a slope of the first inclined plane is different from a slope of the second inclined plane.

7. The display device according to claim 6, wherein a connection of the first inclined plane and the second inclined plane forms a protrusion or a recess.

8. The display device according to claim 4, wherein the first light guide comprises a first district, a second district, and a center line between the first district and the second district, the center line is parallel to the first direction, the first district and the second district are disposed on opposite sides of the center line, and a shape of the first units disposed in the first district and a shape of the first units disposed in the second district are symmetrical with respect to the center line.

9. The display device according to claim 8, wherein each of the first units comprises a first inclined plane and a second inclined plane, a connection of the first inclined plane and the second inclined plane forms a protrusion or a recess, a slope of the first inclined plane is less than a slope of the second inclined plane, the first inclined plane is disposed near the center line and the second inclined plane is disposed away from the center line.

10. An operation method of a display device, comprising:
providing a display device, comprising:
a display panel;
a light-controlling module disposed under the display panel, wherein the light-controlling module comprises:
a first light guide comprising a plurality of first microstructures, wherein the first microstructures extend along a first direction;
a second light guide disposed on the first light guide and comprising a plurality of second microstructures, wherein the second microstructures extend along the second direction, and the first direction is perpendicular to the second direction; and
a diffusion structure disposed on the second light guide and comprising a plurality of diffusion microstructures, wherein each of the diffusion microstructures comprises an arc surface;
a first light source disposed on two opposite sides of the first light guide in the first direction;
a second light source disposed on two opposite sides of the second light guide in the second direction; and
a third light source disposed under the first light guide;
turning on one of the first light source and the second light source; and
turning on at least a part of the third light source or turning off the third light source.

11. The operation method of the display device according to claim 10, wherein when at least a part of the third light source is on, a first region of the third light source is on and a second region of the third light source is off.

12. The operation method of the display device according to claim 10, wherein when all the third light source is on, a brightness of the third light source is less than 20% of a maximum brightness of the third light source.

13. The operation method of the display device according to claim 10, wherein the first microstructures are arranged in a second direction, any two adjacent first microstructures have a first spacing in the second direction, and the first spacings are gradually reduced from two opposite edges of the first light guide towards an interior of the first light guide in the second direction.

14. The operation method of the display device according to claim 10, wherein the second microstructures are arranged in a first direction, any two adjacent second microstructures have a second spacing in the first direction, and the second spacings are gradually reduced from two opposite edges of the second light guide towards an interior of the second light guide in the first direction.
